(19) United States
(12) Patent Application Publication
(10) Pub. No.: US 2005/0169325 A1
(43) Pub. Date: Aug. 4, 2005

(54) Laser cavity with variable dispersion element

(76) Inventors: Jochen Schwarz, Stuttgart (DE); Ulrich Kallmann, Tubingen (DE); Emmerich Mueller, Aidingen (DE); Bernd Nebendahl, Ditzingen (DE); Wolf Steffens, Herrenberg (DE); Hansjoerg Haisch, Altdorf (DE)

Correspondence Address: PERMAN & GREEN, 425 POST ROAD, FAIRFIELD, CT, 06824, US

(21) Appl. No.: 10/504,384

(22) PCT Filed: May 17, 2002
(86) PCT No.: PCT/EP02/05443

(51) Int. Cl. H01S 3/10; H01S 3/08

(52) U.S. Cl. 372/20; 372/92; 372/102

(57) ABSTRACT

The invention relates to a method of tuning a laser, comprising the steps of: providing a laser beam (4) in an external cavity (2) having a dispersion element (10) for selecting at least one mode of the laser, varying the wavelength characteristic of the dispersion element (10).

### BACKGROUND OF THE INVENTION

The present invention relates to tuning a laser with an external laser cavity.

In the optical communication industry there is a need for testing e.g. optical components and amplifiers with lasers at different wavelengths. For this purpose, various types of laser cavities are known.

Tunable lasers are described e.g. as the so-called Littman geometry in “Liu and Littman, Novel geometry for single-mode scanning of tunable lasers, Optical Society of America, 1981”, or as the so-called Littrow geometry in EP 0 952 643 A2. Bragg-reflector type cavities are shown e.g. “A. Nahata et al., Widely Tunable Semiconductor Laser Using Dynamic Holographically-Defined Distributed. Bragg Reflector, 2000 IEEE”. The teaching of those documents shall be incorporated herein by reference.

### SUMMARY OF THE INVENTION

It is an object of the invention to provide improved tuning of a laser. The object is solved by the independent claims.

For the sake of clarity, the terms ‘vary’, ‘variation’, ‘variable’, etc. as used herein are to be interpreted as an intended changing of a property.

An advantage of a preferred embodiment of the present invention is the possibility of (e.g. non-mechanically) performing a compensation for deviations, e.g. geometrical or optical deviations, in the laser cavity setup to provide mode hop free tuning of the laser. Furthermore, it is possible to (e.g. non-mechanically) tune the laser according to a preferred embodiment of the invention.

In a preferred embodiment the variation of the wavelength characteristic of the dispersion element is done by using a periodic structure as the dispersion element and varying the wavelength characteristic of the dispersion element by varying the periodicity of the periodic structure. The variation of the periodicity of the periodic structure can be done by varying the length of a substrate for the periodic structure.

Alternatively or additionally it can be done by using as a material for the substrate any material having a voltage-, magnetism-, pressure-, humidity-, light- and/or temperature-sensitive length, and varying the length of the material by varying the voltage, magnetism, pressure, humidity, light and/or temperature applied to the material.

Alternatively or additionally, it can also be done by using a chirped Bragg grating as the dispersion element and varying the wavelength characteristic of the dispersion element by moving the chirped Bragg grating. A chirped Bragg grating is a grating in which the period of the grating varies with position in the grating. The moving of the chirped Bragg grating can be performed by at least one of the following: translating the chirped Bragg grating, rotating the chirped Bragg grating.

Moreover, alternatively or additionally it is possible to vary the periodicity of the periodic structure by using variable electromagnetic or acoustic waves creating a periodic structure or acting on a periodic structure. The variability of the waves comprising at least one of the following: varying their wavelength, varying the angle of incidence on the variable periodic structure.

Due to deviations of real geometry with respect to perfect configuration and/or chromatic dispersion of the necessary optical components, in inventive embodiments using a geometry for continuous tenability, e.g. a Littman or Littrow geometry, a pivot point can generally only be found for a limited wavelength range. According to the present invention, corrections of these deviations or of the dispersion are made by varying the wavelength characteristic of the dispersion element in order to provide mode hop free tuning in an enlarged tuning range of the cavity.

In preferred embodiments of the inventive apparatus to perform the inventive method the shifting or rotation of the chirped Bragg grating relative to the laser beam can be driven by a piezo-electric translocating element which can precisely shift or rotate the grating.

Other preferred embodiments are shown by the dependent claims.

It is clear that the invention can be partly embodied or supported by one or more suitable software programs, which can be stored on or otherwise provided by any kind of data carrier, and which might be executed in or by any suitable data processing unit.

### BRIEF DESCRIPTION OF THE DRAWINGS

Other objects and many of the attendant advantages of the present invention will be readily appreciated and become better understood by reference to the following detailed description when considering in connection with the accompanied drawings. The components in the drawings are not necessarily to scale, emphasis instead being placed upon clearly illustrating the principles of the present invention. Features that are substantially or functionally equal or similar will be referred to with the same reference sign(s).

FIG. 1-3 show schematic views of embodiments of the apparatus of the present invention;

FIG. 4 shows an example of a variable grating in greater detail;

FIG. 5-7 show schematic views of further embodiments of the apparatus of the present invention.

### DETAILED DESCRIPTION OF THE INVENTION

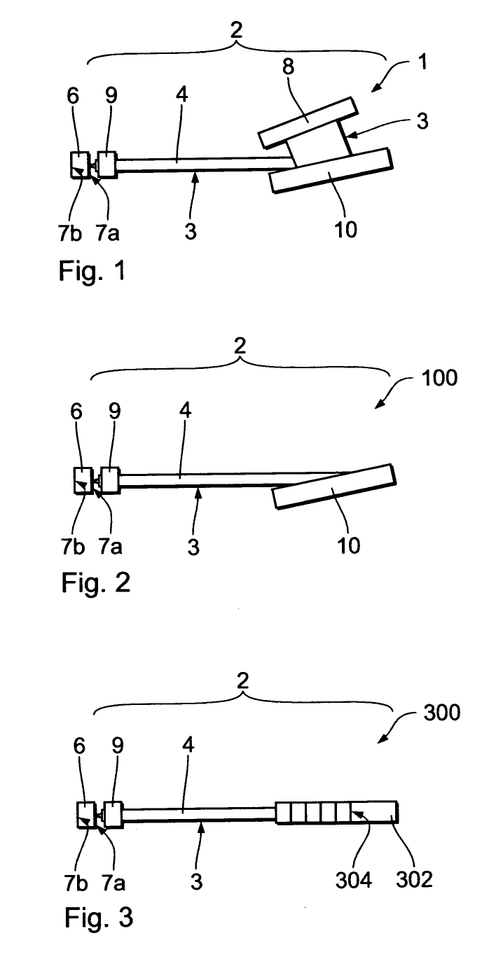

FIG. 1 shows a schematic view of a first embodiment 1 of the apparatus of the present invention. Embodiment 1 comprises an external cavity 2 in which laser light provided by an integrated laser diode 6 as an active medium can resonate to provide a laser beam 4. One side 7b of the laser diode 6 serves as a cavity end element. Beam 4 travels in the cavity 2 along a path 3 between the cavity end element 7b and a tuning element 8, both providing a high-reflective mirror. Beam 4 is focused by a lens 9 in the path 3 on the front side 7a of the laser diode 6.

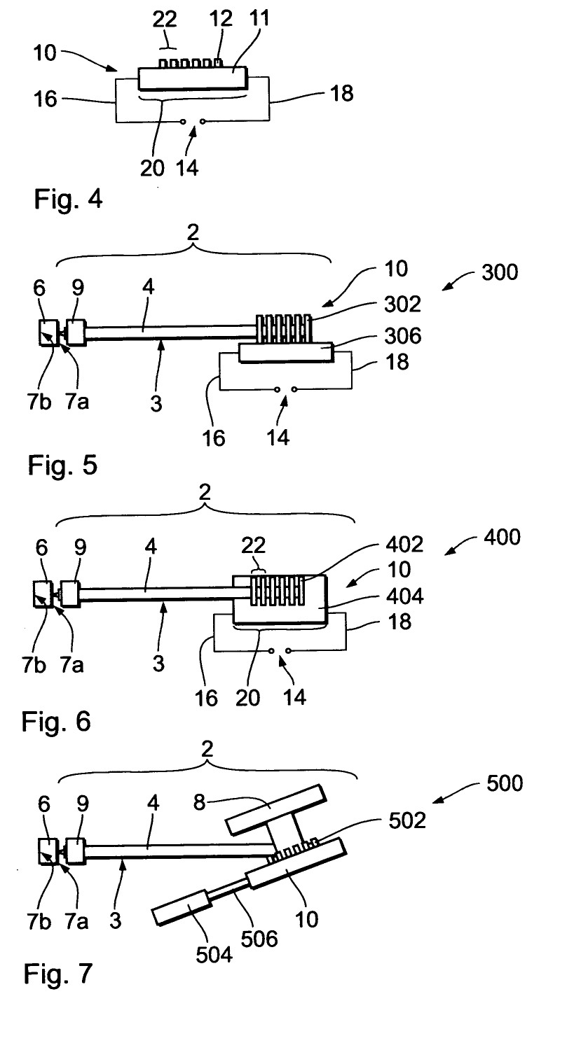

Embodiment 1 further comprises a dispersion element 10 introduced in the path 3 of the beam 4 for selecting at least one (preferably a longitudinal) mode of the laser. The dispersion element 10 comprises a variable grating 12 (see FIG. 4).

Embodiment 1 is configured in a Littman-type configuration. Therefore, the tuning element 8 can be rotated by an actuator (not shown) about a (not shown) pivot axis to tune the laser. The pivot axis is theoretically defined by the intersection of the optical surface planes of the cavity end element 7b of the laser diode 6, the dispersion element 10 and the tuning element 8.

The variable grating 12 of the dispersion element 10 can be varied by varying the wavelength characteristic of the grating 12, i.e. by varying the period of the grating 12. For this purpose the grating 12 is mounted on a substrate. FIG. 4 shows this in greater detail.

FIG. 4 shows the dispersion element 10 with the substrate 11 and the grating 12. The substrate 11 is a piezo-electric element, which can be influenced by a voltage 14 via connecting lines 16 and 18. Varying the voltage 14 will vary the length 20 of the substrate 11. Consequently, the period 22 of the grating 12 will vary accordingly. This variation of period 22 of the grating 12 can compensate a shift between a real position of the pivot axis and a theoretically by the Littman theory defined position. The variation of the grating period 22 has to be done to such an extent that the compensation is sufficient to provide continuous single-mode tuning within a predetermined tuning range of the tuning element 8.

Alternatively, the tuning itself can be done by the variation of the period 22 of the grating 12. This is also done by varying the voltage 14 and therefore the length of the substrate 11.

Alternatively, the compensation or the tuning can be done by varying the length of the substrate with other measures, e.g. with heat, pressure, light, magnetism, humidity and/or temperature.

FIG. 2 shows a second embodiment 100 of the present invention. Embodiment 100 is configured in a Littrow-type configuration. Therefore, the dispersion element 10 serves also as the tuning element. Besides that the dispersion element 10 can be build up by a piezo-electric element, also. Therefore, in embodiment 100 of FIG. 2 the compensation of a shift between a real position of the pivot axis of dispersion element 10 and a theoretically by the Littrow theory defined position and a tuning can both be done by the combined dispersion element 10 comprising a piezo-electric element according to FIG. 4.

As an alternative to the piezo-electric element as the dispersion element 10 of embodiment 1 and 100 a variable periodic index structure can be generated in the dispersion element 10 with light or by sound (not shown). E.g. a periodic light structure exposes a material and the generated carrier density yields a periodic index structure or variable acoustic waves generated by a piezo oscillator or an acusto-optic modulator generate a periodic structure (not shown). The variation of such a periodic light or sound structure can be done by a variation of the irradiation wavelength or a variation of the irradiation angle (not shown).

FIG. 3 shows a third embodiment 300 of the present invention. In embodiment 300 the cavity 2 is configured in a Bragg reflector configuration. Therefore, a Bragg reflector 302 having a variable periodic structure 304 is used. The Bragg reflector 302 can then be mounted on a piezo electric substrate 306 as shown in more detail in FIG. 5. Optionally, it can be etched directly into a piezo-electric substrate (not shown).

Alternatively, as shown in a fourth embodiment 400 according to FIG. 6 the Bragg reflector can be periodically diffused material 402 diffused in a piezo-electric element 404. Then by varying the length 20 of the piezo-electric element 404 the period 22 of the Bragg reflector 402 can be varied to tune the laser. Optionally, other materials can be used instead of piezo-electric material.

FIG. 7 shows a fifth embodiment 500 of the present invention. Embodiment 500 is configured in a Littman-type configuration. Embodiment 500 uses a chirped Bragg grating 502 as a dispersion element 10. By moving the dispersion element 10 with a linear motor 504 connected to the dispersion element 10 by a connector 506 the chirped Bragg grating 502 can be moved and by this the above-mentioned compensation or tuning facility of the present invention is provided.

1. A method of tuning a laser, comprising the steps of:
providing a laser beam in an external cavity having a dispersion element for selecting at least one mode of the laser, wherein the dispersion element has a periodic structure,
varying the wavelength characteristic of the dispersion element by varying a periodicity of the periodic structure, and
controlling the variation to provide at least one of the following steps:
avoiding mode hops in a certain wavelength range when tuning the laser,
tuning the laser, and
at least partly compensating a deviation between an actual and a theoretical geometry of the cavity (2) for a continuous tunability.

2-3. (canceled)

4. The method of claim 1, wherein the step
varying the periodicity of the periodic structure comprises a step of varying a
length of a substrate for the periodic structure.

5. The method of claim 4, wherein the step
varying the length of the substrate comprises the steps of:
using as a material for the substrate any material having at least one of the following: a voltage-, magnetism-, pressure-, humidity-, light-, temperature-sensitive length, preferably by using as the material a piezo-electric material and
varying the length of the material by varying at least one of the following: the voltage, magnetism, pressure, humidity, light, temperature applied to the material.

6. The method of claim 1, wherein
the dispersion element comprises a chirped Bragg grating, and
the step of varying the wavelength characteristic of the dispersion element comprises a step of moving the Bragg grating.

7. The method of claim 6, wherein the step of moving the Bragg grating comprises at least one of the following steps of: translating the Bragg grating relative to the laser beam, and rotating the Bragg grating relative to the laser beam.

8. The method of claim 1, wherein the step of
varying the periodicity of the periodic structure comprises a step of using variable waves acting on the periodic structure.

9. The method of claim 8, wherein the step of using variable waves comprises at least one of:
using variable electromagnetic waves, and using variable acoustic waves.

10. (canceled)

11. The method of claim 8, wherein
the variability of the waves comprises at least one of the following: varying their wavelength, varying the angle of incidence on the variable periodic structure.

12. The method of claim 1, wherein a rotating tuning element is used in a cavity having an optical path length and the cavity being of Littman or Littrow type, the method further comprising the steps of:
at least approximately evaluating a function which determines the quantity of variation of the optical path length for generating mode or wavelength hop free rotating of the tuning element within a predetermined tuning range of the tuning element as a function of the rotation angle of the tuning element by:
(a) substantially detecting mode or wavelength hops during rotation of the tuning element,
(b) rotating the tuning element about a predetermined angle until at least one mode or wavelength hop has substantially occurred,
(c) varying the optical path length by an arbitrary quantity by varying the wavelength characteristic of the dispersion element,
(d) rotating back the tuning element about the predetermined angle of step (b),
repeating steps (a) to (d) with increasing or decreasing quantity of variation of step (c) until substantially no mode or wavelength hops during rotation of the tuning element are detected in step (b),
using the quantity of variation of step (c) per rotating angle of step (b) to evaluate an approximation of the function that determines the quantity of variation of the optical path length per rotating angle of the tuning element.

13. The method of claim 12, further comprising the step of:
varying the optical path length according to the approximation function before or while rotating the tuning element.

14. The method of claim 13, further comprising the steps of:
measuring the quantity of variation of the variation of the optical path length,
comparing the measured value with the predetermined value, adjusting the quantity of variation when detecting a difference between the measured value and the predetermined value.

15. The method of claim 12, further comprising at least one of the steps of:
modulating the variation of the optical path length of the path, modulating the variation of the periodicity of the grating.

16. (canceled)

17. An apparatus for tuning a laser, comprising:
an external cavity,
a dispersion element for selecting at least one mode of the laser, the dispersion element having a variable wavelength characteristic, and
a control unit adapted for varying the wavelength characteristic of the dispersion element in order to provide at least one of the following:
avoiding mode hops in a certain wavelength range when tuning the laser, tuning the laser, at least partly compensating a deviation between an actual and a theoretical geometry of the cavity for a continuous tunability,
wherein the dispersion element comprises a periodic structure, so that the wavelength characteristic of the dispersion element is variable by varying the periodicity of the periodic structure.

18-19. (canceled)

20. The apparatus of claim 17, further comprising:
a substrate for the periodic structure, the substrate having a variable length.

21. The apparatus of claim 20, wherein:
wherein a material for the substrate comprises and material having at least one of the following: a voltage-, magnetism-, pressure-, humidity-, light-, temperature-sensitive length, and
the apparatus comprises a unit means for varying the length of the material by varying at least one of the following: the voltage, magnetism, pressure, humidity, light, temperature applied to the material.

22. The apparatus of claim 17,
wherein the dispersion element comprises a chirped Bragg grating, so that the wavelength characteristic of the dispersion element is variable relative to the laser beam by moving the Bragg grating.

23. The apparatus of claim 22,
wherein the wavelength characteristic of the chirped Bragg grating is variable relative to the laser beam by at least one of the following: translating the Bragg grating relative to the laser beam, rotating the Bragg grating relative to the laser beam.

24. The apparatus of further comprising:
a piezo-electric translocating element for doing at least one of the following: translating the Bragg grating relative to the laser beam, rotating the Bragg grating relative to the laser beam.

25. The apparatus of claim 17,
wherein the periodicity of the periodic structure is variable by variable waves acting on the periodic structure.

26. The apparatus of claim 25,
wherein the periodicity of the periodic structure variable by at least one of:
variable electromagnetic waves and variable acoustic waves.

27. (canceled)

28. The apparatus of claim 25, further comprising:
a varying element for varying the waves by one of the following: varying their wavelength, varying the angle of incidence on the variable periodic structure.

29. The apparatus of claim 17,
wherein the external cavity is of one of the following types: Littman, Littrow, Bragg-reflector.

30. A dispersion element for use in the apparatus of claim 17, comprising:
a variable periodic structure, so that the wavelength characteristic of the dispersion element is variable by varying the periodicity of the periodic structure.
